(19) United States
(12) Patent Application Publication
(10) Pub. No.: US 2015/0006116 A1
(43) Pub. Date: Jan. 1, 2015

(54) SYSTEMS AND METHODS FOR DESIGNING FOAM TRENCH AND HOG RING WINDOW

(71) Applicant: Infosys Limited, Bangalore (IN)

(72) Inventors: Umesh Prakash Handigol, Bangalore (IN); Mohammad Asger Ali Shaik, Tenali (IN)

(73) Assignee: INFOSYS LIMITED, Bangalore (IN)

(21) Appl. No.: 14/220,110

(22) Filed: Mar. 19, 2014

(30) Foreign Application Priority Data
Jul. 1, 2013 (IN) 2901/CHE/2013

(51) Int. Cl. G06F 17/50

(52) U.S. Cl. CPC G06F 17/50
USPC 703/1

(57) ABSTRACT

The technique relates to a system and method for designing foam trench and hog ring window. This technique involves allowing a user to provide input regarding the dimensions of the foam trench and hog ring window. Further, this technique prompts a user to select an insert surface and seam-line surface. The intersection curve of the insert surface and seam-line surface is computed, and the midpoint of the intersection curve is determined. Then, an axis system is created at the midpoint of the intersection curve. Finally, a sketch of the foam trench and hog ring window is generated on a plane of the axis system based on the one or more dimensions specified by the user.

### FIELD

The present disclosure relates generally to designing a foam trench and hog ring window, and in particular, to a system and method for designing a foam trench and hog ring window based on user input.

### BACKGROUND

A trench is a cutout or depression provided in seat foam throughout and following the seam profile. It provides the base for the seat foam i.e. trim attachment and also accommodates the seam stitch marks. The trenches vary in dimensions depending on the type of attachment used. A hog-ring window is a local cutout or depression provided at various places below the trench where the actual trim-foam attachment takes place. In designing automotive seating foam, the creation of the trench and hog ring windows are one of the major time-consuming tasks because, throughout its design cycle, it has to undergo numerous iterations before the design is frozen. There are different types of trim attachment methods for which dimensions of trench and hog ring window will change. These dimensions may also vary based on special requirements by OEMs (Original Equipment Manufacturer) and these get modified in numerous iterations. Because of all these factors, creation of trench and hog ring windows in an automotive seating foam pad becomes major, time-consuming and monotonous task.

Presently there are a few techniques available in the market to create the foam trench and hog ring window, but the techniques have few limitations. The existing techniques requires laborious and monotonous human efforts in creating and modifying trench and hog ring windows throughout the design phase of seating foam pad. These numerous iterations in creating trench and hog ring windows lead to delay in faster execution and decrease in productivity.

### SUMMARY

The present disclosure overcomes the above-mentioned techniques by using a tool to create foam trench and hog ring window. This tool automates creation of trench and hog ring windows and the human intervention will require only at the initial stage. Further, the tool drastically reduces the time consumed when compared with the existing methodology. The time reduction is achieved primarily by reducing human intervention and secondarily by automating the iterations in a logical sequence.

According to an embodiment, a method for designing foam trench and hog ring window is disclosed. The method includes receiving one or more dimensions specified by a user to design the foam trench and hog ring window. After that, an insert surface and a seam-line surface are received and an intersection curve of the insert surface and the seam-line surface is computed. Thereafter, a midpoint of the intersection curve is computed. Further, an axis system at the midpoint of the intersection curve is created. Finally, a sketch of the foam trench and hog ring window is generated on a plane of the axis system based on the one or more dimensions specified by the user.

In an additional embodiment, a system for designing foam trench and hog ring window is disclosed. The system includes a dimension receiving module, a surface selection module, a intersection curve computation module, a midpoint computation module, a axis system creation module and a sketch generation module. The dimension receiving module is configured to receive one or more dimensions specified by a user to design the foam trench and hog ring window. The surface selection module is configured to prompt the user to select an insert surface and a seam-line surface. The intersection curve computation module is configured to compute an intersection curve of the insert surface and the seam-line surface. The midpoint computation module is configured to compute a midpoint of the intersection curve. The axis system creation module is configured to create an axis system at the midpoint of the intersection curve and the sketch generation module is configured to generate a sketch of the foam trench and hog ring window on a plane of the axial system based on the one or more dimensions specified by the user.

In another embodiment, a computer-readable storage medium for designing foam trench and hog ring window is disclosed. The computer-readable storage medium which is not a signal stores computer executable instructions for receiving one or more dimensions specified by a user to design the foam trench and hog ring window, receiving an insert surface and a seam-line surface, computing an intersection curve of the insert surface and the seam-line surface, computing a midpoint of the intersection curve, creating an axis system at the midpoint of the intersection curve and generating a sketch of the foam trench and hog ring window on a plane of the axis system based on the one or more dimensions specified by the user.

### DRAWINGS

Various embodiments of the invention will, hereinafter, be described in conjunction with the appended drawings. There is no intention to limit the scope of the invention to such blocks or objects, or to any particular technology. Instead these simplified diagrams are presented by way of illustration to aid in the understanding of the logical functionality of one or more aspects of the instant disclosure and is not presented by way of limitation.

FIG. 1 is a computer architecture diagram illustrating a computing system capable of implementing the embodiments presented herein.

FIG. 2 is a flowchart, illustrating a method for designing foam trench and hog ring window, in accordance with an embodiment of the present invention.

FIG. 3 illustrates an axis system at the midpoint of the intersection curve, in accordance with an embodiment of the present invention.

FIG. 4 is a block diagram illustrating a system for designing foam trench and hog ring window, in accordance with an embodiment of the present invention.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

Exemplary embodiments of the present invention provide a system and method for designing foam trench and hog ring window. This involves allowing user to provide input regarding the dimensions of the foam trench and hog ring window. Further, this technique prompts user to select an insert surface and seam-line surface. The intersection curve of the insert surface and seam-line surface is computed and the midpoint of the intersection curve is determined. Then, an axis system is created at the midpoint of the intersection curve. Finally, a sketch of the foam trench and hog ring window is generated on a plane of the axis system based on the one or more dimensions specified by the user.

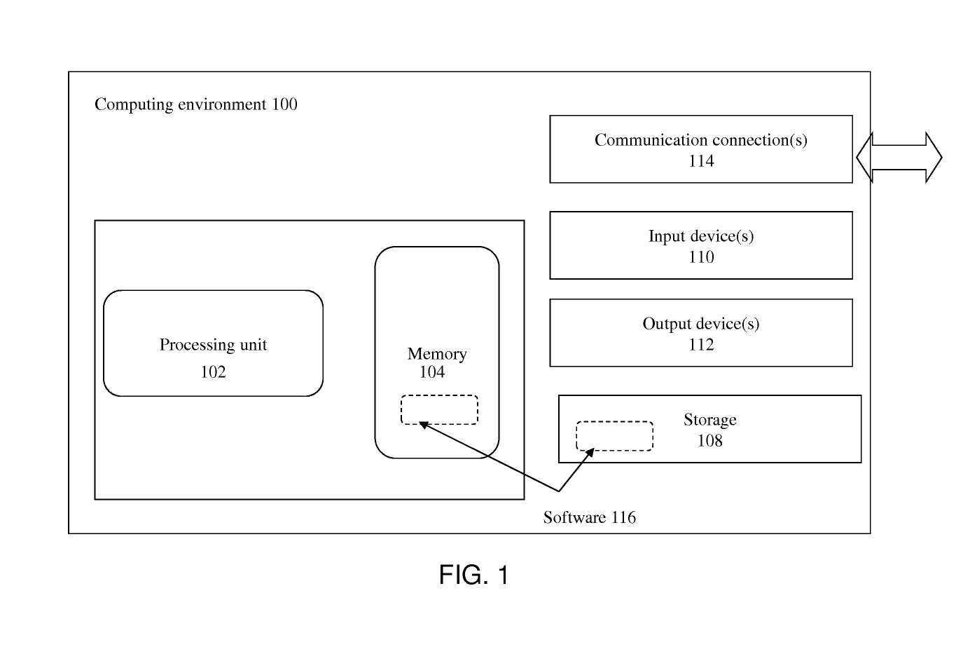

FIG. 1 illustrates a generalized example of a suitable computing environment 100 in which all embodiments, techniques, and technologies of this invention may be implemented. The computing environment 100 is not intended to suggest any limitation as to scope of use or functionality of the technology, as the technology may be implemented in diverse general-purpose or special-purpose computing environments. For example, the disclosed technology may be implemented using a computing device (e.g., a server, desktop, laptop, hand-held device, mobile device, PDA, etc.) comprising a processing unit, memory, and storage storing computer-executable instructions implementing the service level management technologies described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like.

With reference to FIG. 1, the computing environment 100 includes at least one central processing unit 102 and memory 104. The central processing unit 102 executes computer-executable instructions. In a multi-processing system, multiple processing units execute computer-executable instructions to increase processing power and as such, multiple processors can be running simultaneously. The memory 104 may be volatile memory (e.g., registers, cache, RAM), non-volatile memory (e.g., ROM, EEPROM, flash memory, etc.), or some combination of the two. The memory 104 stores software 116 that can implement the technologies described herein. A computing environment may have additional features. For example, the computing environment 100 includes storage 108, one or more input devices 110, one or more output devices 112, and one or more communication connections 114. An interconnection mechanism (not shown) such as a bus, a controller, or a network, interconnects the components of the computing environment 100. Typically, operating system software (not shown) provides an operating environment for other software executing in the computing environment 100, and coordinates activities of the components of the computing environment 100.

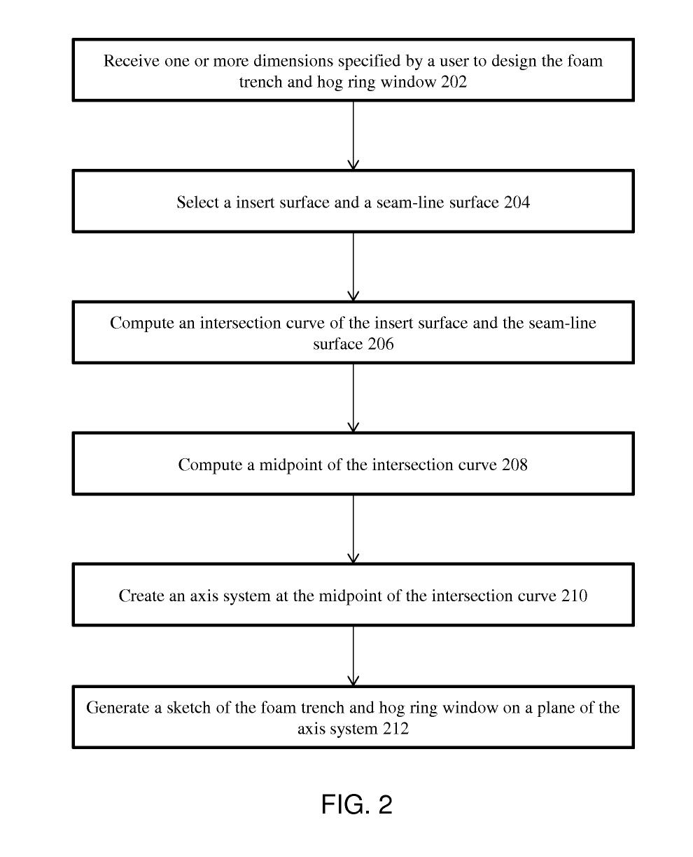

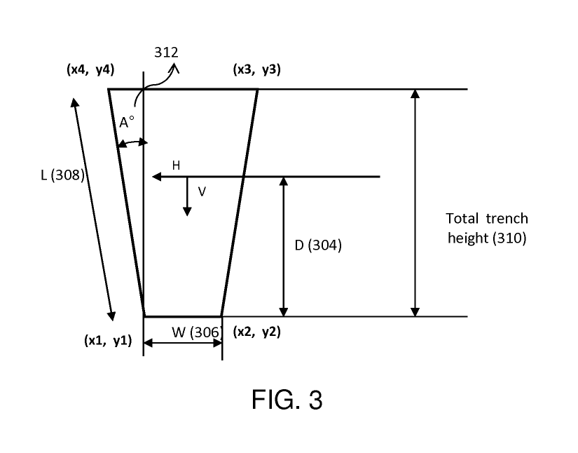

FIG. 2 is a flowchart, illustrating a method for designing foam trench and hog ring window, in accordance with an embodiment of the present invention. As in step 202, one or more dimensions specified by a user to design the foam trench and hog ring window are received by the tool. This allows the user to customize the size of the foam trench and hog ring window. In various embodiments of the present disclosure, the user has a freedom to select the type of foam, foam trench and hog ring window apart from providing desired dimensions. Selection can be made either in graphic window or in design tree. Different types of foam may include back foam and cushion foam, different types of trench may include vertical trench and horizontal trench. Again, different types of hog ring window may include dove tail and rectangular. The one or more dimensions to design the foam trench include width of trench bottom surface, depth of the trench bottom surface from the insert surface and draft angle of the trench. The one or more dimensions to design the hog ring window include depth of the hog ring window from trench bottom surface, length of the hog ring window and number of the hog ring window. The user selected insert surface and seam-line surface are received by the processor, as in step 204. Once the user selects insert and seam-line surface the tool computes the intersection curve of the insert and seam-line surface, as in step 206. The intersection curve is then smoothened by using curve smooth option. Then, the midpoint of the smoothened curve is created, as in step 208. A line is generated at the midpoint and normal to the curve. For example, in case of horizontal trench, the line is generated normal to insert surface at the midpoint. An axis system is created at the midpoint of the curve aligning X-axis of the axis system to the previously generated line, as in step 210. Then, the sketch is generated on the appropriate plane on the axis system based on dimensions specified by the users, as in step 212. The method of generating the sketch and the underlying calculations can be described with the help of FIG. 3.

In FIG. 3 the user inputs to create foam trench include trench depth (D) (304), trench width (W) (306) and Draft angle A (312). Bottom co-ordinates (x1, y1) and (x2, y2) is calculated from user inputs as follows:

x1=W/2

y1=D; and

x2=−(W/2)

y2=D

For calculating co-ordinates for top two points, i.e. (x3, y3) and (x4, y4) the length of the side arm and slope of the same are computed. For calculating the length and slope the total height of the trench solid (310) is limited to 30 mm. this value is customizable as per the need. Now, length, L, is calculated using the following formula:

L=30/Sin (A)

Then, the slope “m” of the line is calculated by using the following formula:

m=Tan (A)

Now, co-ordinates (x3, y3) and (x4, y4) is calculated as follows:

x3=x2−L/\sqrt{1+m2}

y3=y2+m(x3−x2); and

x4=−(x3)

y4=y3

Once all the four co-ordinates are generated, a cross section of trench is created by joining the lines through those points. The generated sketch is iso-constrained. After that, a rib is created using the sketch as profile and smoothened intersection curve as a guide. In case of vertical trenches, seam-line surface is used as reference surface for the rib. In case of vertical trenches, ramp-up is created on both ends at 50 mm from the end points of the intersection curve. Again, 45° planes are created at the end points and the rib is split between these planes. User can change the distance and angle as per the requirement. Then, all the edges are filleted with 2 mm radius. After that, points are created on trench center curve and points are equally distributed along its length. The distance between the points can be changed by the user as per the requirement. The number of points depends on the user input of the number of hog ring windows. These points are the centers of the hog ring windows. A plane normal to the curve at this point is created. Further, two planes on either side of the hog ring window center plane is created as per the user input for “length for hog ring window”. Then, a sketch is generated on the same plane as that of trench sketch based on the user inputs on type and depth of the hog ring window. A rib is created along with the trench path and get split by the said two planes.

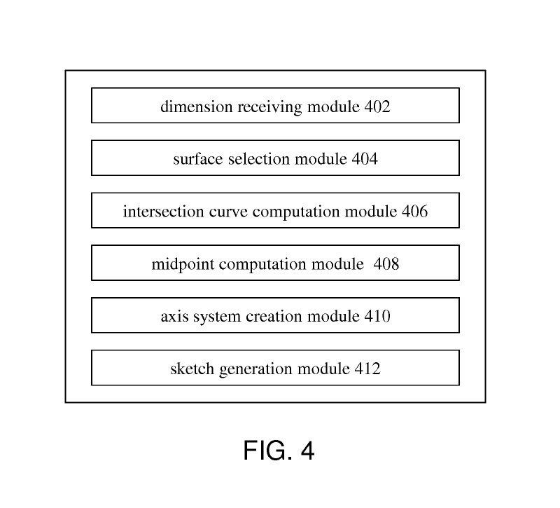

FIG. 4 is a block diagram illustrating a system for designing foam trench and hog ring window, in accordance with an embodiment of the present invention. The system includes a dimension receiving module 402, a surface selection module 404, a intersection curve computation module 406, a midpoint computation module 408, a axis system creation module 410 and a sketch generation module 412. The dimension receiving module 402 is configured to receive one or more dimensions specified by a user to design the foam trench and hog ring window. This allows the user to customize the size of the foam trench and hog ring window. In various embodiments of the present disclosure, the user has a freedom to select the type of foam, foam trench and hog ring window apart from providing desired dimensions. Selection can be made either in graphic window or in design tree. Different types of foam may include back foam and cushion foam, different types of trench may include vertical trench and horizontal trench. Again, different types of hog ring window may include dove tail and rectangular. The one or more dimensions to design the foam trench include width of trench bottom surface, depth of the trench bottom surface from the insert surface and draft angle of the trench. The one or more dimensions to design the hog ring window include depth of the hog ring window from trench bottom surface, length of the hog ring window and number of the hog ring window. The surface selection module 404 is configured to prompt the user to select an insert surface and a seam-line surface. The intersection curve computation module 406 is configured to compute an intersection curve of the insert surface and the seam-line surface. The intersection curve is smoothened by using curve smooth option. The midpoint computation module 408 is configured to compute a midpoint of the intersection curve. A line is generated at the midpoint and normal to the curve. For example, in case of horizontal trench, the line is generated normal to insert surface at the midpoint. The axis system creation module 410 is configured to create an axis system at the midpoint of the intersection curve. The X-axis of the axis system is aligned to the previously generated line. The sketch generation module 412 is configured to generate a sketch of the foam trench and hog ring window on a plane of the axial system based on the one or more dimensions specified by the user. The method of generating the sketch and the underlying calculations is described in detail with the help of FIG. 3 herein above. Once all the four co-ordinates are generated, a cross section of trench is created by joining the lines through those points. The generated sketch is iso-constrained. After that, a rib is created using the sketch as profile and smoothened intersection curve as a guide. In case of vertical trenches, seam-line surface is used as reference surface for the rib. In case of vertical trenches, ramp-up is created on both ends at 50 mm from the end points of the intersection curve. Again, 45° planes are created at the end points and the rib is split between these planes. User can change the distance and angle as per the requirement. Then, all the edges are filleted with 2 mm radius. After that, points are created on trench center curve and points are equally distributed along its length. The distance between the points can be changed by the user as per the requirement. The number of points depends on the user input of the number of hog ring windows. These points are the centers of the hog ring windows. A plane normal to the curve at this point is created. Further, two planes on either side of the hog ring window center plane is created as per the user input for “length for hog ring window”. Then, a sketch is generated on the same plane as that of trench sketch based on the user inputs on type and depth of the hog ring window. A rib is created along with the trench path and get split by the said two planes.

One or more computer-readable media (e.g., storage media) or one or more processor-readable media (e.g., storage media) can comprise computer-executable instructions causing a computing system (e.g., comprising one or more processors coupled to memory) (e.g., computing environment 100 or the like) to perform any of the methods described herein. Examples of such computer-readable or processor-readable media include magnetic media, optical media, and memory (e.g., volatile or non-volatile memory, including solid state drives or the like).

The above mentioned description is presented to enable a person of ordinary skill in the art to make and use the invention and is provided in the context of the requirement for obtaining a patent. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

What is claimed is:

1. A computer-implemented method for designing a foam trench and hog ring window comprising:
receiving, by a processor, one or more dimensions specified by a user to design the foam trench and hog ring window;
receiving, by the processor, an insert surface and a seam-line surface;
computing, by the processor, an intersection curve of the insert surface and the seam-line surface;
computing, by the processor, a midpoint of the intersection curve;
creating, by the processor, an axis system at the midpoint of the intersection curve; and
generating, by the processor, a sketch of the foam trench and hog ring window on a plane of the axis system based on the one or more dimensions specified by the user.

2. The method as claimed in claim 1, wherein the foam trench comprises a vertical trench and a horizontal trench.

3. The method as claimed in claim 1, wherein the user is enabled to select a type of foam and hog ring window.

4. The method as claimed in claim 3, wherein the type of the foam includes either back or cushion foam.

5. The method as claimed in claim 3, wherein the type of hog ring window includes either dove tail or rectangular.

6. The method as claimed in claim 1, wherein the one or more dimensions to design the foam trench comprise width of trench bottom surface, depth of the trench bottom surface from the insert surface and draft angle of the trench.

7. The method as claimed in claim 1, wherein the one or more dimensions to design the hog ring window comprise depth of the hog ring window from trench bottom surface, length of the hog ring window and number of the hog ring window.

8. The method as claimed in claim 1, wherein the intersection curve is smoothened by using a curve smooth option.

9. The method as claimed in claim 1, wherein the sketch is generated by creating lines through four co-ordinates derived from the one or more dimensions specified by the user.

10. The method as claimed in claim 1 further comprising:
creating at least one rib by using the sketch as profile and the intersection curve as a guide.

11. A system for designing foam trench and hog ring window comprising:
a processor in operable communication with a processor-readable storage medium, the processor-readable storage medium containing one or more programming instructions whereby the processor is configured to implement:
a dimension receiving module configured to receive one or more dimensions specified by a user to design the foam trench and hog ring window;
a surface selection module configured to prompt the user to select an insert surface and a seam-line surface;
a intersection curve computation module configured to compute an intersection curve of the insert surface and the seam-line surface;
a midpoint computation module configured to compute a midpoint of the intersection curve;
a axis system creation module configured to create an axis system at the midpoint of the intersection curve; and
a sketch generation module configured to generate a sketch of the foam trench and hog ring window on a plane of the axial system based on the one or more dimensions specified by the user.

12. The system as claimed in claim 11, wherein the foam trench comprises a vertical trench and a horizontal trench.

13. The system as claimed in claim 11, wherein the user is enabled to select a type of foam and hog ring window.

14. The system as claimed in claim 13, wherein the type of the foam includes either back or cushion foam.

15. The system as claimed in claim 13, wherein the type of hog ring window includes either dove tail or rectangular.

16. The system as claimed in claim 11, wherein the one or more dimensions to design the foam trench comprise width of trench bottom surface, depth of the trench bottom surface from the insert surface and draft angle of the trench.

17. The system as claimed in claim 11, wherein the one or more dimensions to design the hog ring window comprise depth of the hog ring window from trench bottom surface, length of the hog ring window and number of the hog ring window.

18. The system as claimed in claim 11, wherein the intersection curve is smoothened by using a curve smooth option.

19. The system as claimed in claim 11, wherein the sketch is generated by creating lines through four co-ordinates derived from the one or more dimensions specified by the user.

20. The system as claimed in claim 11 further comprising:
a rib creation module configured to create at least one rib by using the sketch as profile and the intersection curve as a guide.

21. A non-transitory computer-readable medium having computer executable instructions stored thereon for designing foam trench and hog ring window, the said instructions comprising:
instructions for receiving one or more dimensions specified by a user to design the foam trench and hog ring window;
instructions for receiving an insert surface and a seam-line surface;
instructions for computing an intersection curve of the insert surface and the seam-line surface;
instructions for computing a midpoint of the intersection curve;
instructions for creating an axis system at the midpoint of the intersection curve; and
instructions for generating a sketch of the foam trench and hog ring window on a plane of the axis system based on the one or more dimensions specified by the user.

22. The non-transitory computer-readable medium as claimed in claim 21, wherein the foam trench comprises vertical trench and horizontal trench.

23. The non-transitory computer-readable medium as claimed in claim 21, wherein the one or more dimensions to design the foam trench comprise width of trench bottom surface, depth of the trench bottom surface from the insert surface and draft angle of the trench.

24. The non-transitory computer-readable medium as claimed in claim 21, wherein the one or more dimensions to design the hog ring window comprise depth of the hog ring window from trench bottom surface, length of the hog ring window and number of the hog ring window.

25. The non-transitory computer-readable medium as claimed in claim 21, wherein the intersection curve is smoothened by using a curve smooth option.

26. The non-transitory computer-readable medium as claimed in claim 21, wherein the sketch is generated by creating lines through four co-ordinates derived from the one or more dimensions specified by the user.
